(19) United States
(12) Patent Application Publication
(10) Pub. No.: US 2024/0022479 A1
(43) Pub. Date: Jan. 18, 2024

(54) CU-UP Node Selection Based on Endpoints Discovery

(71) Applicant: Dell Products L.P., Round Rock, TX (US)

(72) Inventors: Vikas Arora, Ottawa (CA); Ravi Sharma, Santa Clara, CA (US)

(21) Appl. No.: 17/812,201

(22) Filed: Jul. 13, 2022

(51) Int. Cl. H04L 41/12; H04L 41/0803; H04L 41/16

(52) U.S. Cl. CPC H04L 41/12; H04L 41/0803; H04L 41/16

(57) ABSTRACT

Generally provided is a system for determining unknown, new and/or changed radio system architecture/topology, including available system connections between nodes, NFs, CU-UPs, DUs and/or CU-CPs. An example system can comprise a processor; and a memory that stores executable instructions that, when executed by the processor, facilitate performance of operations, comprising determining a request from a user equipment (UE) for network access, and selecting a central unit user plane (CU-UP) to which to assign the UE based on a known aspect of a network topology of a communication network comprising the CU-UP. The system can provide a learned and dynamic approach to network topology analysis, and can allow for determining a CU-UP based on network topology, connection availability, loading, downtime, traffic connections, bandwidth and/or one or more other KPIs.

### BACKGROUND

Modern cellular systems continue to advance, where various components of a respective network can be disaggregated and/or managed by multiple vendors. In this way, architecture is not always known for node deployment, user entity access and/or the like. Indeed, architecture availability and/or configuration can change absent full knowledge by all vendors. This can result in varying qualities of service, architecture availabilities and/or the like for different user entities of a network, or for different vendors on the network.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

Generally provided is a system for determining unknown, new and/or changed radio system architecture/topology, including available system connections between nodes, NFs, CU-UPs, DUs and/or CU-CPs.

An example system can comprise a processor; and a memory that stores executable instructions that, when executed by the processor, facilitate performance of operations, comprising determining a request from a user equipment (UE) for network access, and selecting a central unit user plane (CU-UP) to which to assign the UE based on a known aspect of a network topology of a communication network comprising the CU-UP.

An example method can comprise generating, by a system comprising a processor, table data representative of a mapping table of topology connections of a network topology comprising an open radio access network topology or at least a fifth generation (5G) communication network topology, and based on the mapping table, selecting, by the system, a central unit user plane of the network topology to which to assign a user device associated with a user entity that is requesting access to the network topology.

An exemplary non-transitory machine-readable medium, comprising executable instructions that, when executed by a processor facilitate performance of operations, comprising detecting topology connections of a network topology, comparing central unit user planes (CU-UPs) of the network topology, based on the topology connections, and determining a CU-UP of the CU-UPs to which to assign the UE based on a result of the comparing.

An advantage of the one or more embodiments of the aforementioned system, method and/or non-transitory machine-readable medium can be learning, by the system, of which CU-UP to target, such as for node deployment or a user entity requesting access to the radio network.

Another advantage of the one or more embodiments of the aforementioned system, method and/or non-transitory machine-readable medium can be ability to address changed, new, and/or damaged topology connections via discovery over time and subsequent topology learning by the system.

Yet another advantage of the one or more embodiments of the aforementioned system, method and/or non-transitory machine-readable medium can be ability to navigate a topology having a disaggregated architecture where different vendors provide different connection KPIs.

In one or more embodiments of the aforementioned system, method and/or non-transitory machine-readable medium, analysis of known topology connections can be performed using an analytical model, such as an artificial intelligence model, where the determining of a CU-UP can comprise determining the CU-UP based on a result of the analyzing. An advantage of these one or more processes can be a learned and dynamic approach to network topology analysis, and can allow for determining a CU-UP not only based on network topology availability, but additionally and/or alternatively upon one or more other criteria, such as loading, downtime, traffic connections, bandwidth and/or one or more other learned context or KPIs of a radio network topology.

### BRIEF DESCRIPTION OF THE DRAWINGS

The technology described herein is illustrated by way of example and not limited in the accompanying figures, in which like reference numerals indicate similar elements.

FIG. 1 illustrates a schematic representation of example elements of a radio system/network, in accordance with one or more embodiments and/or implementations described herein.

FIG. 2 illustrates an exemplary O-RAN architecture topology of the radio system of FIG. 1, in accordance with one or more embodiments and/or implementations described herein.

FIG. 3 illustrates a schematic representation of a topology analysis system that can analyze and map the architecture topology of FIG. 2, in accordance with one or more embodiments and/or implementations described herein.

FIG. 4 illustrates another schematic representation of a topology analysis system that can analyze and map the architecture topology of FIG. 2, in accordance with one or more embodiments and/or implementations described herein.

FIG. 5 illustrates a partial schematic diagram of general processes performed by the topology analysis system of FIG. 4, in accordance with one or more embodiments and/or implementations described herein.

FIG. 6 illustrates a schematic of signals and processing requests at the topology of FIG. 2 to perform one or more processes of the diagram of FIG. 5, in accordance with one or more embodiments and/or implementations described herein.

FIG. 7 illustrates a process flow diagram of a method of radio system topology analysis by the topology analysis system of FIG. 4, in accordance with one or more embodiments and/or implementations described herein.

FIG. 8 illustrates a continuation of the process flow diagram of a method of radio system topology analysis by the topology analysis system of FIG. 4, in accordance with one or more embodiments and/or implementations described herein.

FIG. 9 illustrates a block diagram of an example operating environment into which embodiments of the subject matter described herein can be incorporated.

FIG. 10 illustrates an example schematic block diagram of a computing environment with which the subject matter described herein can interact and/or be implemented at least in part, in accordance with one or more embodiments and/or implementations described herein.

### DETAILED DESCRIPTION

### Overview

The technology described herein is generally directed towards a process to select a node of a network based on a network having a learned topology and/or one or more unknown topology aspects, such as topology connections. That is, one or more embodiments described herein can provide for determining unknown, new and/or changed radio system architecture/topology, including available system connections between nodes, such as NFs, CU-UPs, DUs and/or CU-CPs.

More particularly, the technology described herein is directed to detecting topology between DUs and CU-UPs using 3GPP defined procedures and messages, such as bearer context setup procedures. Caching can enable the sue of discovered topology to perform selection of CU-UPs for bearer creation procedures.

In conventional frameworks, since O-RAN architecture is based on disaggregated nodes, it can be desired to select a node to process traffic for a flow from the available pool of nodes. However, conventional generic mechanisms defined by 3GPP are based on known network slice and topology. When topology is unknown, when multiple CU-UPs exist within a slice or when multiple slices are available, it can be desired to better understand the network topology for selection of the node. For example, 3GPP configuration data models do not have gNB transport topology defined at O-CU-CP level, and thus O-CU-CP does not have any available means to consider transport connectivity between O-CU-UPs and O-DUs while selecting an O-CU-UP from the available pool.

Indeed, disaggregated O-RAN gNB may have multiple instances of CU-UPs and DUs and 3GPP/O-RAN specifications/interfaces are agnostic of transport topology between CU-UPs and DUs. Further, not all DUs may be in mesh networking with all CU-UPs, and thus a selected CU-CP has to select a CU-UP from the pool that is connected to the DU that controls the cell where a call has originated from. That is, in absence of topology information at the CU-CP, there is a challenge with CU-UP selection at the CU-CP, such as when multiple CU-UPs exist in a gNB.

Conventional frameworks can select a node without having full information about network topology, context and/or node KPIs, and thus such selection can lead to unbalanced nodes, decreased bandwidth, radio system downtime, reduced quality of service, network degradation of one or more KPIs and/or the like.

To account for one or more of these deficiencies, one or more systems, methods and/or non-transitory computer readable mediums are defined herein that can provide in-situ, dynamic and/or realtime analysis of network topology, including node connections between CU-CP, CU-UPs and DUs. For example, a knowledge base can be employed to store a set of identified topology aspects, such as topology connections of a radio network. The knowledge base alternatively and/or additionally can store data regarding KPIs, loading, quality of service, bandwidth and/or the like correlated to one or more nodes and/or particular connections. An analytical model can employ the knowledge base, such as being trained on the data therein, to generate a node selection when access to the radio network is requested or when a node is requested for one or more other reasons, which can comprise, but are not limited to user-plane load balancing, user-plane power savings, and/or other user-plane resource relocation.

To provide these one or more operations and/or features, reference throughout this specification to “one embodiment,” “an embodiment,” “one implementation,” “an implementation,” etc. means that a particular feature, structure, or characteristic described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations.

As used herein, with respect to any aforementioned and below mentioned uses, the term “in response to” can refer to any one or more states including, but not limited to: at the same time as, at least partially in parallel with, at least partially subsequent to and/or fully subsequent to, where suitable.

As used herein, the term “entity” can refer to a machine, device, smart device, component, hardware, software and/or human.

As used herein, the term “cost” can refer to power, money, memory, processing power, manual labor, thermal power, size, weight and/or the like.

As used herein, the term “resource” can refer to power, money, memory, processing power and/or the like.

### Example Radio System Architectures

One or more embodiments are now described with reference to the drawings, where like referenced numerals are used to refer to like elements throughout. In the following description, for purposes of explanation, numerous specific details are set forth to provide a more thorough understanding of the one or more embodiments. It is evident, however, in various cases, that the one or more embodiments can be practiced without these specific details.

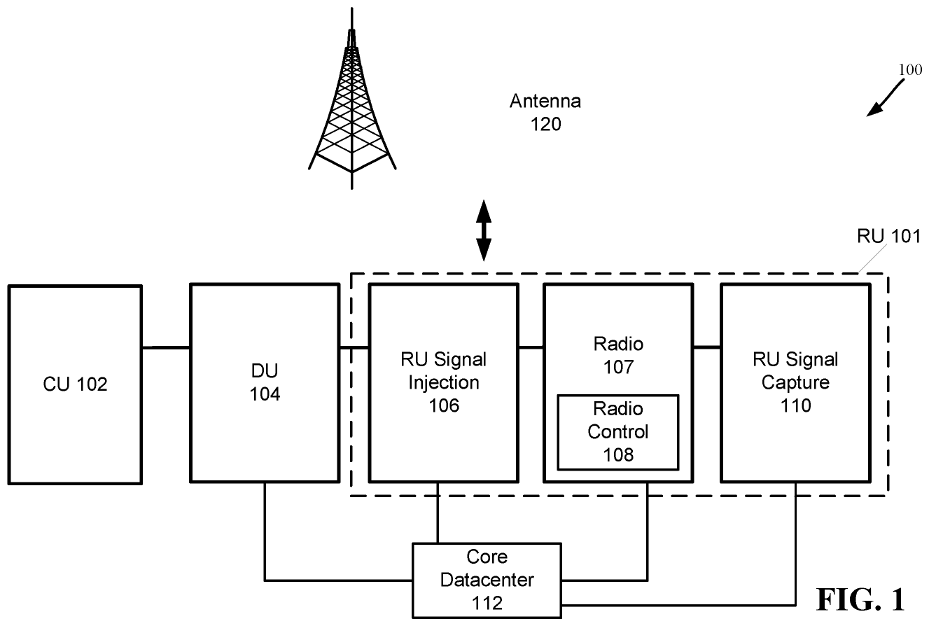

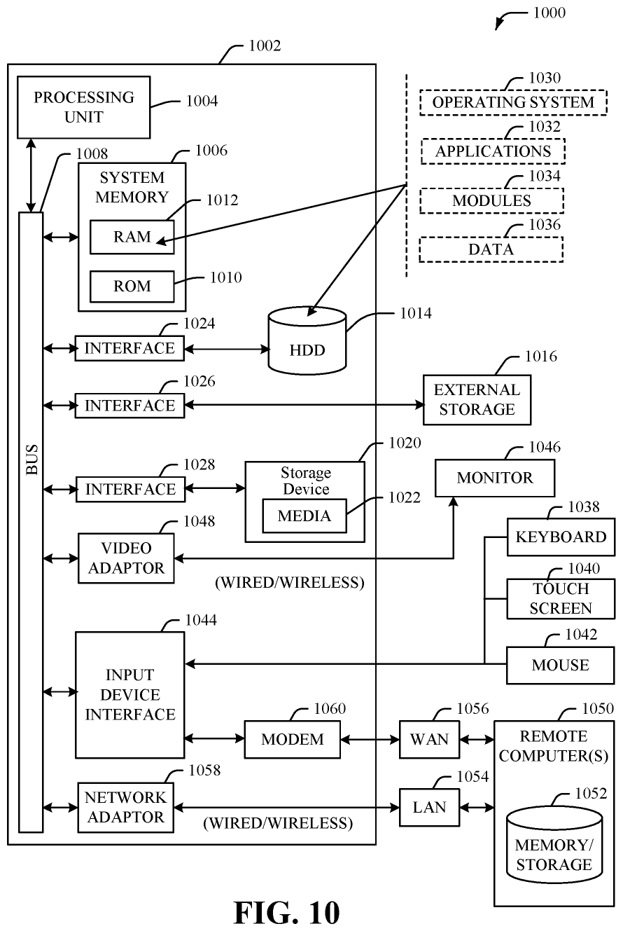

Further, the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting system architecture 100 as illustrated at FIG. 1, and/or systems thereof, can further comprise one or more computer and/or computing-based elements described herein with reference to an operating environment, such as the operating environment 1000 illustrated at FIG. 10. In one or more described embodiments, computer and/or computing-based elements can be used in connection with implementing one or more of the systems, devices, components and/or computer-implemented operations shown and/or described in connection with FIG. 1 and/or with other figures described herein.

Turning now to FIG. 1, a high-level radio system architecture is illustrated at 100. The radio system 100 can comprise a central unit (CU) 102, distributed unit (DU) 104 (also herein referred to as a DU portion 104) and a radio unit (RU) 101. The CU 102 can comprise protocol layers and can be responsible for various protocol stack functions. The RU 101 can comprise a radio unit (RU) signal injection portion 106 (also herein referred to as an RU signal injection portion 106), the radio control 108, and an RU signal capture portion 110. Generally, the DU portion 104 can provide both baseband processing and RF functions. The RU signal capture portion 110 can take signals from a respective antenna 120 and convert the RF signal into a data signal, and vice versa. In one or more embodiments, the RU signal capture portion 110 can analyze data captured. The DU portion 104 and RU portion 106 can provide data to, and receive data from, the core datacenter 112 and/or central management system.

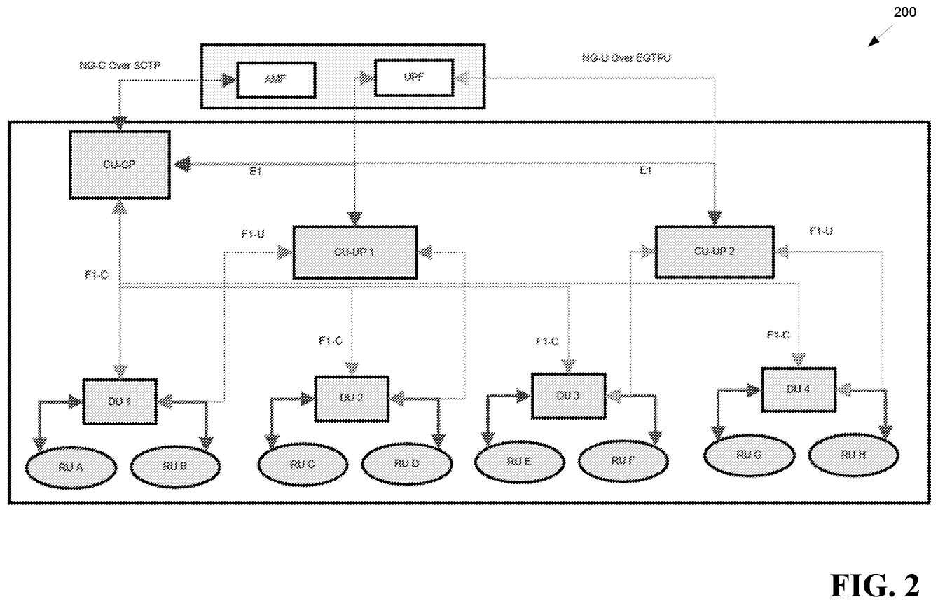

Turning next to FIG. 2, an example of a radio system architecture 200 is illustrated. Comprised by the radio system architecture 200 is a central unit control plane (CU-CP), a plurality of centralized unit user planes (CU-UPs), a plurality of distributed units (DUs), and a plurality of radio units (RU). The CU-CP has extending therefrom the CU-UPs, the DUs extend from the CU-UPs, and the RUs extend from the DUs. An E1 connection can connect the CU-CP and CU-UPs. F1 connections can connect the CU-UPs with the DUs, and also the DUs with the CU-CP. These can be different F1 connections managed by different vendors.

E1 is a 3 GPP defined interface between CU-CP and CU-UP network functions. E1-AP protocol can be used over this interface.

F1 is a 3GPP defined interface between CU-CP, CU-UP and the DU. It can have two types: F1-c and F1-u. F1-c is the control plane link between CU-CP and DU, while F1-u is a data plane link between CU-UP and DU. F1-AP protocol can be used over the F1-c while NR user plane (NR-UP) protocol can be used over F1-u.

Additionally, access and mobility management function (AMF) is the control plane function in 5GC. It can manage the UE sessions and mobility for the gNBs under its control. CU-CP node in gNB connects to AMF in 5G core (5GC). NG-C is the interface between CU-CP and AMF, which can operate with stream control transmission protocol (SCTP).

User plane function (UPF) is the data plane function and can transfer user data to/from CU-UP in gNB over GTP-U tunnels. NG-U is the interface between CU-UP and UPF, which can operate with extended GPRS tunneling protocol for user plane (E-GTPU).

It is appreciated that one or more other radio networks than can function with and/or utilize one or more radio network topology analysis systems described herein can have different topology. In one or more embodiments, one or more aspects (e.g., nodes) of the network topology 200 can be omitted. In one or more embodiments, one or more additional aspects (e.g., nodes) can be added to a network topology. In one or more embodiments, any one or more connections (e.g., between aspects, such as nods) can be different.

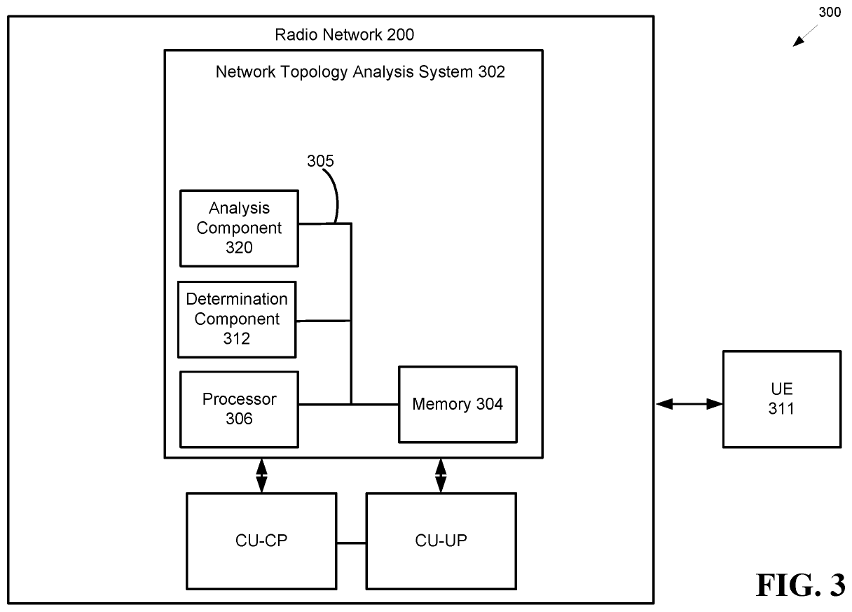

Turning next to FIG. 3, an example non-limiting system 300 is illustrated comprising a network topology analysis system 302 and the radio network 200. The topology analysis system 302 can be coupled to and be comprised by the network topology 200. In one or more other embodiments, the network topology analysis system 302 can be separate from but coupled to the radio network 200.

For purposes of brevity, additional aspects of the radio system 100 (e.g., as illustrated at FIG. 1) and/or network topology 200 are not illustrated at FIG. 3. While referring here to one or more processes, operations, facilitations and/or uses of the non-limiting system architecture 300, description provided herein, both above and below, also can be relevant to one or more other non-limiting system architectures described herein.

The topology analysis system 302 can generally determine unknown, new and/or changed radio system architecture/topology, including available system connections between nodes, NFs, CU-UPs, DUs and/or CU-CPs. For example, the topology analysis system 302 can comprise a determination component 312 that can determine a request from a user equipment (UE) 311 for network access (e.g., access to a radio network coupled to the topology analysis system 302, such as the radio network topology 200). An analysis component 320 can select a central unit user plane (CU-UP) to which to assign the UE 311 based on a known aspect of a network topology of a communication network comprising the CU-UP.

The known aspect can be a known connection, node loading, desired quality of service, desired bandwidth, and/or another context.

As used herein, a node can refer to an instance of a CU-UP function. Node loading can refer to CU-UP load.

One or more aspects of a component (e.g., the determination component 312 and/or analysis component 320) can be employed separately and/or in combination, such as employing one or more of the memory 304 or the processor 306. Additionally, and/or alternatively, the processor 306 can execute one or more program instructions to cause the processor 306 to perform one or more operations by these components. The bus 305 can enable local communication between the elements of the topology analysis system 302.

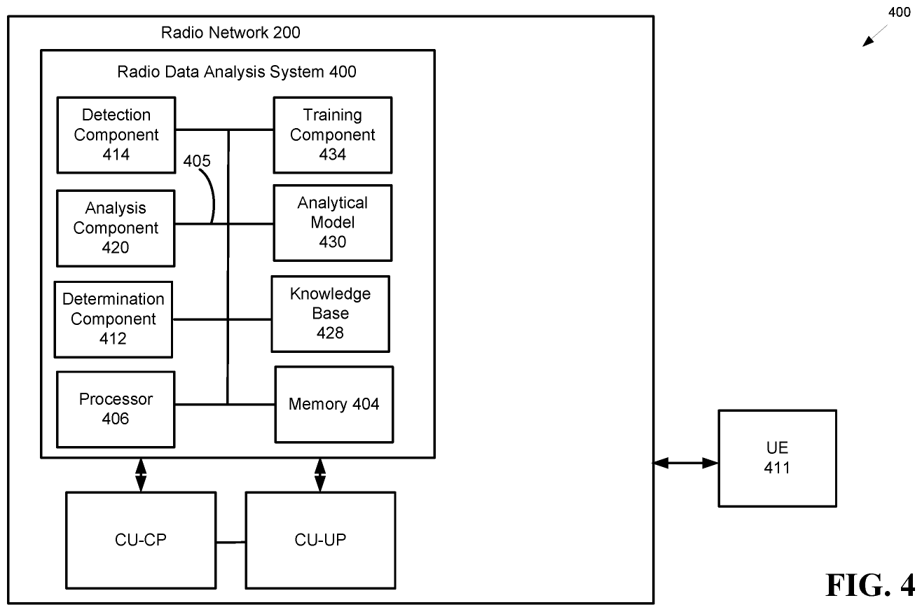

Turning next to FIG. 4, an example of a non-limiting architecture is illustrated at 400, comprising a topology analysis system 402 and the radio network 200. The topology analysis system 402 can be coupled to and be comprised by the network topology 200. In one or more other embodiments, the network topology analysis system 402 can be separate from but coupled to the radio network 200.

For purposes of brevity, additional aspects of the radio system 100 (e.g., as illustrated at FIG. 1) and/or network topology 200 are not illustrated at FIG. 4. While referring here to one or more processes, operations, facilitations and/or uses of the non-limiting system architecture 400, description provided herein, both above and below, also can be relevant to one or more other non-limiting system architectures described herein.

The topology analysis system 402 can generally determine unknown, new and/or changed radio system architecture/topology, including available system connections between nodes, NFs, CU-UPs, DUs and/or CU-CPs. Generally, the topology analysis system 402 can comprise any suitable computing devices, hardware, software, operating systems, drivers, network interfaces and/or so forth. However, for purposes of brevity, only components generally relevant to network function configurations are illustrated in FIG. 4. For example, the topology analysis system 402 can comprise a processor 406, memory 404, bus 405, determination component 412, detection component 414, analysis component 420, training component 434, knowledge base 428 and/or analytical model 430.

Discussion first turns to the processor 306, memory 304 and bus 305 of the topology analysis system 402.

In one or more embodiments, topology analysis system 402 can comprise the processor 406 (e.g., computer processing unit, microprocessor, classical processor and/or like processor). In one or more embodiments, a component associated with topology analysis system 402, as described herein with or without reference to the one or more figures of the one or more embodiments, can comprise one or more computer and/or machine readable, writable and/or executable components and/or instructions that can be executed by processor 406 to facilitate performance of one or more processes defined by such component(s) and/or instruction(s). In one or more embodiments, the processor 406 can comprise the determination component 412, detection component 414, analysis component 420, training component 434, knowledge base 428 and/or analytical model 430.

The processor 406 can be configured to control one or more components/elements of the topology analysis system 402, such as the determination component 412, detection component 414, analysis component 420, training component 434, knowledge base 428 and/or analytical model 430.

In one or more embodiments, the topology analysis system 402 can comprise the machine-readable memory 404 that can be operably connected to the processor 406. The memory 404 can store computer-executable instructions that, upon execution by the processor 406, can cause the processor 406 and/or one or more other components of the topology analysis system 402 (e.g., determination component 412, detection component 414, analysis component 420, training component 434, knowledge base 428 and/or analytical model 430) to perform one or more actions. In one or more embodiments, the memory 404 can store one or more computer-executable components.

Topology analysis system 402 and/or a component thereof as described herein, can be communicatively, electrically, operatively, optically and/or otherwise coupled to one another via a bus 405 to perform functions of non-limiting system architecture 400, topology analysis system 402 and/or one or more components thereof and/or coupled therewith. Bus 405 can comprise one or more of a memory bus, memory controller, peripheral bus, external bus, local bus and/or another type of bus that can employ one or more bus architectures. One or more of these examples of bus 405 can be employed to implement one or more embodiments described herein.

In one or more embodiments, topology analysis system 402 can be coupled (e.g., communicatively, electrically, operatively, optically and/or like function) to one or more external systems (e.g., a system management application), sources and/or devices (e.g., classical communication devices and/or like devices), such as via a network. In one or more embodiments, one or more of the components of the non-limiting system architecture 400 can reside in the cloud, and/or can reside locally in a local computing environment (e.g., at a specified location(s)).

In addition to the processor 406 and/or memory 404 described above, topology analysis system 402 can comprise one or more computer and/or machine readable, writable and/or executable components and/or instructions that, when executed by processor 406, can facilitate performance of one or more operations defined by such component(s) and/or instruction(s).

Turning now to additional elements of the topology analysis system 402, the determination component 412 can generally determine a request from a user equipment (UE) 411 for network access to the network topology 200. The request can be obtained via any suitable means and/or any suitable communication type. Further, the determination component 412 can determine the CU-UP as one of a group of CU-UPs of the network topology 200 that are initially determined as comprising a connection to a distributed unit (DU) having received the request from the UE 411.

The detection component 414 can generally detect topology connections of the network topology that comprise the known aspect, wherein the known aspect can be a topology connection, node loading, KPI and/or other context/aspect of the network discussed herein. For example, based on CU-UP and CU-CP responses during requests between these nodes, the detection component 414 can determine that connections exist and are functioning between the CU-UPs and CU-CP, between the CU-UPs and DUs, and between the DUs and CU-CP. The detection component 414 can update a knowledge database 428 with these topology aspects (e.g., the known topology connections).

The knowledge base 428 can be disposed at the topology analysis system 402 as illustrated, and/or can be external to the topology analysis system 402 and/or radio network 200. Additional knowledge bases can be employed by the topology analysis system 402 where applicable.

In one or more embodiments, the knowledge base 428 can include any other suitable network aspects, such as current node loading, desired bandwidth settings, quality of service thresholds and/or the like. This information can be gained by the detection component 414 from the messages sent among the network topology 200 and/or can be specified by an administrator entity. The knowledge base 428 can be updated at any suitable frequency with new and/or unknown network aspects, such as connections and/or other aspects, to thereby build a useful compendium of topology data.

For example, from the topology data, the analysis component 420 can generate a current topology connection map of the network topology 200. This map can be employed by the analysis component 420 in selecting a node (e.g., a CU-UP) to which to assign the UE 411.

The knowledge base 428 also can be updated upon determination by the detection component 414 that a previously known topology aspect (e.g., topology connection, loading, and/or the like) has changed. In one or more embodiments, a topology connection can be down or no longer functioning. That is, where a previously known topology connection is not accessible, such as where no response is returned to a node of the network topology 200, the detection component 414 can request repeat sending of the message between the nodes and/or wait for future messages to be sent without a request from the detection component 414. That is, the detection component 414 can temporarily maintain the state of the knowledge database 428 relative to the topology connection that is non-responsive, non-functioning and/or the like. After a specified number of attempts, unsuccessful responses and/or the like, it can be determined that the previously known topology connection is no longer available, and the topology connection can be deleted from knowledge database 428 and/or corresponding data of non-availability of the topology connection can be added to the knowledge database 428. Such threshold can be specified by an administrator entity, for example. Via these processes, errant updating of the knowledge database 428 relative only to a temporarily-unavailable (temporarily down), but functioning, topology connection can be avoided.

In this way, the topology information at the knowledge database 428 can be maintained and updated dynamically, such as automatically, by the network topology analysis system 400. Indeed, in one or more embodiments, a network topology analysis system 400 can be implemented for a network topology where a corresponding knowledge database has little or no information on the network topology. That is, the network topology analysis system 400 can, over time, via analysis of messages among the nodes of the network topology, build the knowledge database 428.

Further, in one or more embodiments, the detection comment 414 itself, and/or via request to the CU-CP, can query distributed units that are part of the network topology 200 for connection of the DUs to at least one of the CU-UPs. Any data, such as available topology connections, resulting therefrom can be added to the knowledge database 428 and thus set for use by the analysis component 420.

Turning now back to the request from the UE 411, in response to the request, the analysis component 420 can select a CU-UP to which to assign the UE 411, such as based on one or more known aspects of the network topology 200 comprising the CU-UP. The analysis component 420 can make this determination employing the data compiled at the knowledge base 428. Again, such aspects can be merely availability/functioning of a topology connection. Such aspects can additionally and/or alternatively comprise any one or more other aspects such as node loading, node KPIs, desired quality of service, desired bandwidth, and/or the like.

In one or more embodiments, the analysis component 420 can analyze one CU-UP at a time, in any suitable order, to determine the first available CU-UP (and/or CU-UP meeting any specified threshold criteria as indicated above).

In one or more embodiments, the analysis component 420 can analyze more than one CU-UP at a time. For example, topology aspects of different CU-UPs can be compared to one another, and the CU-UP having the best scoring, such as based on the different topology aspects, can be selected by the analysis component 420.

In one or more embodiments, an analytical model 430 can be employed by the network topology analysis system 402 to generate the aforementioned topology map and/or to make a node selection for use by the analysis component 420.

The analytical model 430 can be, can comprise and/or can be comprised by a classical model, such as a predictive model, neural network, and/or artificial intelligent model. An artificial intelligent model and/or neural network (e.g., a convolutional network and/or deep neural network) can comprise and/or employ artificial intelligence (AI), machine learning (ML), and/or deep learning (DL), where the learning can be supervised, semi-supervised and/or unsupervised. For example, the analytical model 430 can comprise a ML model.

The analytical model 420 can accordingly analyze known data of the knowledge database 428, or of any other KB to make a node selection. In one or more cases, the analytical model 420 can make a prediction of a topology aspect, such as a node loading, based on current and/or historical data at the one or more KB s.

Generally, the analytical model 430 can be trained, such as by the training component 434, on a set of training data that can represent the type of data for which the system will be used. That is, the analytical model 430 can be trained on topology aspects (e.g., topology connections, KPIs, node loading, desired specifications and/or the like).

In one or more embodiments, the training component 434 can, in correspondence with the detection component 414, analyze a response from the CU-UP for an unknown topology aspect, such as associated with an unknown topology connection of the network connection. In response, the training component 434, in correspondence with the detection component 414, can update the knowledge database 428 employed for CU-UP determination with the unknown aspect.

Alternatively, it will be appreciated that the topology analysis system 402 can function absent use of the analytical model 430, such as based on comparison of data from the knowledge base 428 by the analysis component 420.

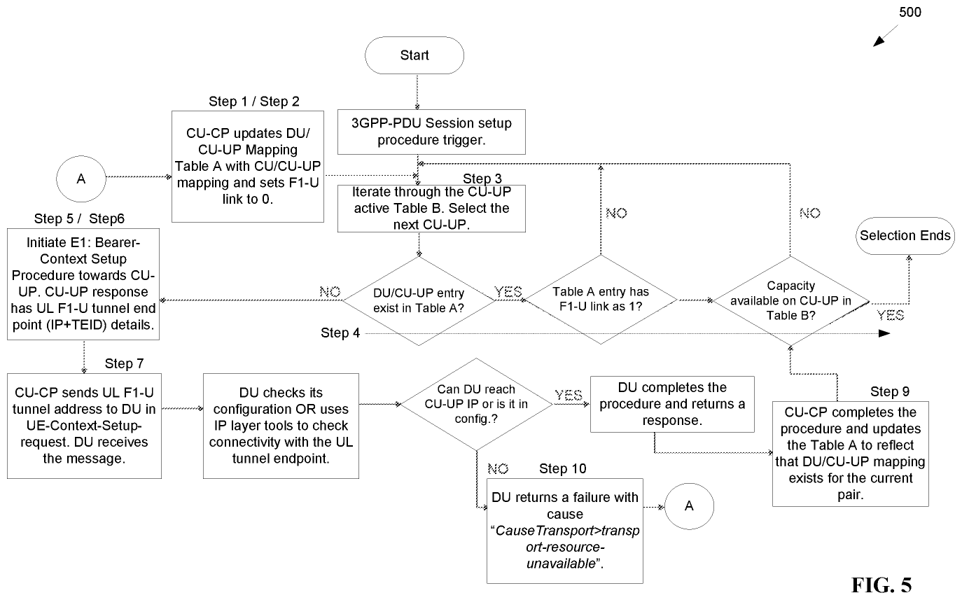

In view of general understanding of the topology analysis system 402, direction now turns to FIG. 5 in addition to still referring to FIG. 4. FIG. 5 illustrates a set of operations relative to FIG. 4 for monitoring and analyzing a topology of a radio network. One or more elements, objects and/or components referenced in the process flow 500 can be those of system 200 and/or system 400. Repetitive description of like elements and/or processes employed in respective embodiments is omitted for sake of brevity. Likewise, the processes and/or operations of the process flow 500 also can be applicable to the system 300.

For example, still referring to FIG. 4, but also referring to FIG. 5, the CU-CP can request from a first CU-UP user plane resources allocation using E1. CU-CP can get an address from the CU-UP, and the CU-CP can then send the address to a DU connected to the CU-UP. In response, the DU can verify the IP received with the CU-UP remote IP configured at the DU. The DU can allocate user plane resources at the DU and respond to the CU-CP with the address. Finally, the CU-CP can send the address to the CU-UP, where the CU-UP can verify the IP with the DU remote IP at the CU-UP. If responses are successful at the CU-CP and CU-UP, the knowledge database 428 and/or a topology map can be updated with the available connections (e.g., endpoints of CU-UP and DU). This first available CU-UP can thus be selected by the analysis component 420.

If, however, a message is returned of unavailable connection to a CUUP by a DU, or if an error is returned, the current CU-UP (e.g., connected to the DU that received the UE request from the UE 411) instead can be selected, such as by the analysis component 420.

Alternatively, the analysis component 420 can, as explained above, conduct additional analysis of other CU-UPs that are known to be associated with the CU-CP of the network topology 200. For example, as indicated above, one or more CU-UPs can be compared based on known topology aspects associated therewith, as provided at the knowledge database 428 and/or as trained at the analytical model 430.

Put another way, and particularly referring to FIG. 5, a series of steps can be employed to select a CU-UP by the analysis component 420 and the topology analysis system 402.

Step 1: O-CU-CP shall store and update the list of all NR-CGI (or a cell) handled by a O-DU using F1SETUP(DU-ID and NR-CGI/PCI) procedure. O-CU-CP shall receive the DU-ID and NR-CGI/PCI as part of F1SetupRequest which is initiated by the O-DU. O-DU is aware of the cells configured on it through its configuration.

Step 2: O-CU-CP shall store the NR-CGI and DU ID mapping for a UE when UE attempts radio connection based on the RRC Setup (NR-CGI) procedure.

Step 3: O-CU-CP shall iterate through the list of available O-CU-UPs and follows the following steps for each of the O-CU-UP in that list:

Step 4: If mapping of the current O-CU-UP, O-CU-CP, and O-DU exists in the internal table, and the current load on O-CU-UP is below the configured threshold, then the current O-CU-UP can be selected for establishment of bearer and the selection procedure can end.

Alternatively, Step 5: O-CU-CP requests O-CU-UP for user plane resources allocation using E1: Bearer-Context-Setup procedure. O-CU-UP shall allocate the UL-UP-TE-ID/IP address for FI-U tunnel during Bearer-Context-Setup procedure.

Step 6: O-CU-CP shall get UL-UP-TE-ID/IP address from O-CU-UP as a part of successful Bearer-Context-Setup (e1ap.uP_TNL_Information) response.

Step 7: O-CU-CP shall send the UL-UP-TE-ID/IP address to O-DU and O-DU verifies the IP received with O-CU-UP remote IP (F1-U remote endpoint) configured at O-DU. Along with this validation, O-DU process the UE-Context-setup-request and allocate user plane resources at O-DU and respond to O-CU-CP with DL-UP-TE-ID/IP.

Step 8: O-CU-CP shall send the DL-UP-TE-ID/IP address to O-CU-UP and O-CU-UP verifies the IP received with O-DU remote IP (NG-U remote endpoint) configured at O-CU-UP. Along with this validation, O-CU-UP process the UE-Bearer-modification-response and respond to O-CU-CP.

Step 9: On successful response, O-CU-CP updates the O-DU<->CELL<->O-CU-UP mapping table in its memory with the endpoints of O-CU-UP and O-DU and the selection procedure can end.

Step 10: On failure response with cause “CauseTransport->transport-resource-unavailable”, the process can return to Step 3. On any other failure, the current O-CU-UP can be considered by the analysis component 420 as the selected instance and the selection procedure can end.

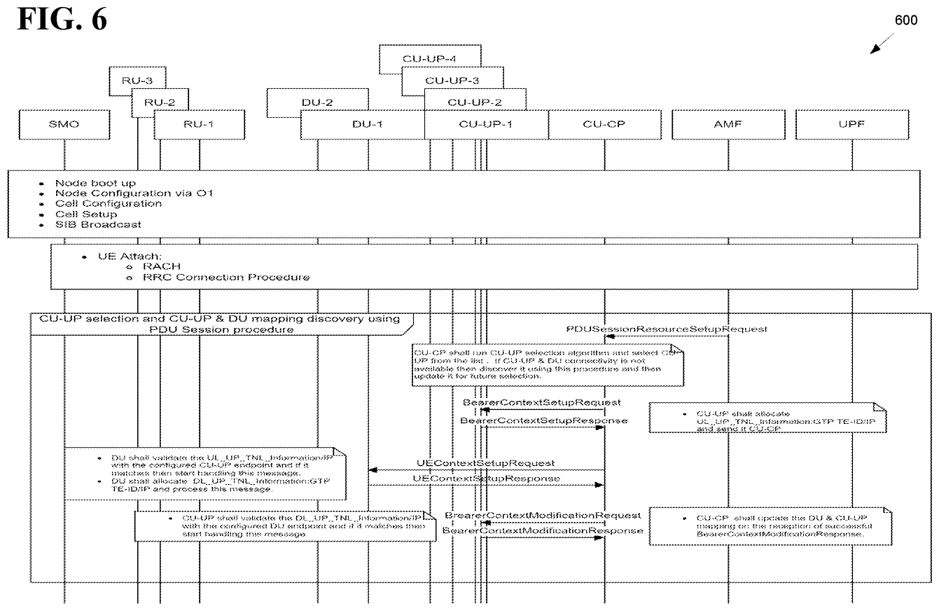

Turning now to FIG. 6, a schematic 600 of signals and processing requests are illustrated relative to the network topology 200 of FIG. 2, and based on the one or more operations performed by the network topology analysis system 400 of FIG. 4. Generally, the schematic 600 provides an alternative view of the one or more operations illustrated at and described relative to FIG. 5, but in a form demonstrating particular signals, messages, requests and/or the like between the various aspects of the network topology 200. That is, generally, FIG. 6 illustrates selection of a node in context of overall flow for PDU session establishment procedure in a gNB.

In view of the foregoing, future requests by future requesting UEs can be made faster and more efficient due to continual/dynamic building of the knowledge database 428 and of any topology map associated therewith. This can particularly be the case relative to a failed connection, returned error of the mapping, implementation absent initial topology provisioning, and/or the like.

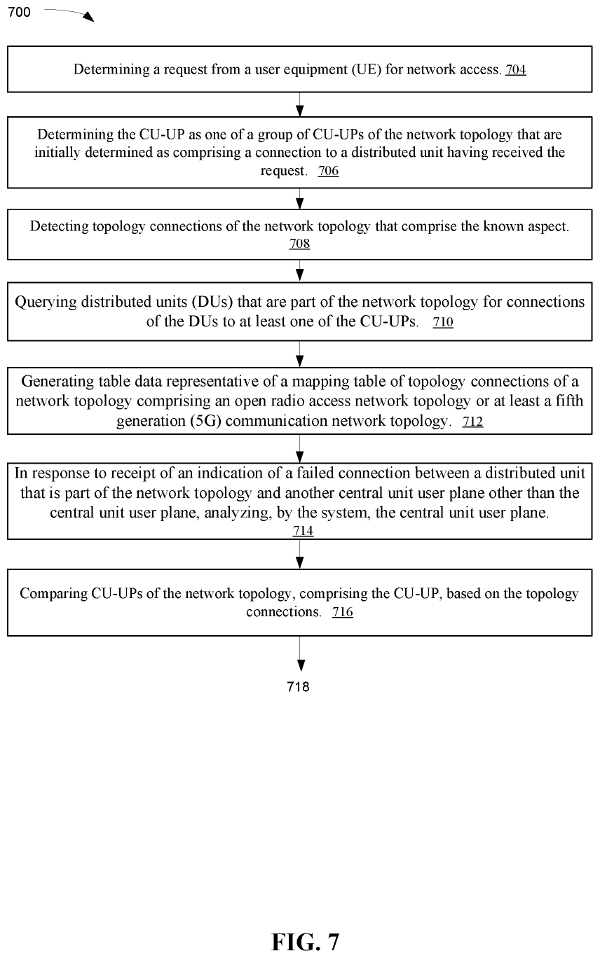

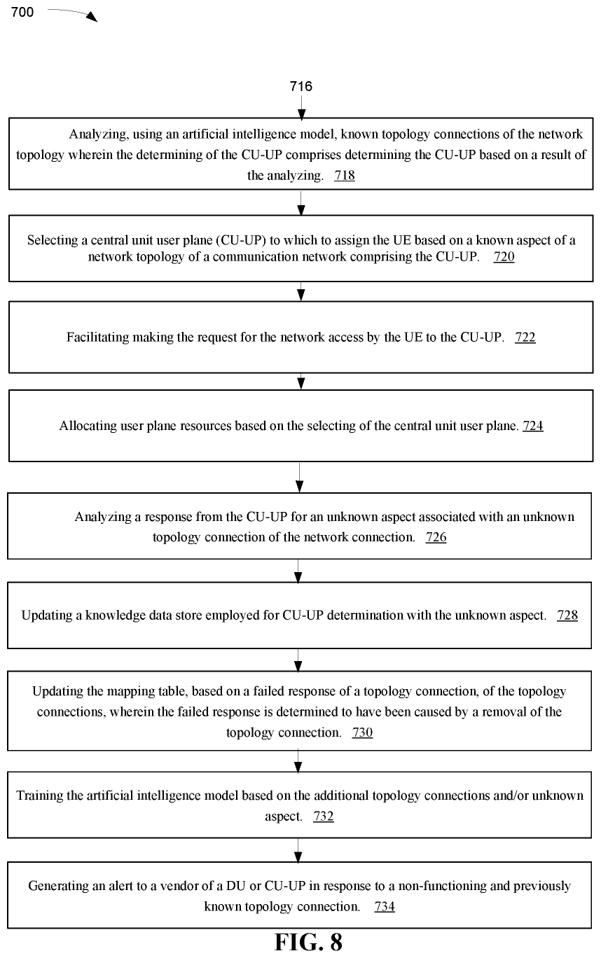

Turning now to FIGS. 7 and 8, a process flow comprising a set of operations is illustrated relative to FIGS. 2 and 4 for analyzing a network topology and for selecting a node of the network topology based on the analysis, in accordance with one or more embodiments described herein. One or more elements, objects and/or components referenced in the process flow 700 can be those of system 200 and/or system 400. Repetitive description of like elements and/or processes employed in respective embodiments is omitted for sake of brevity. Likewise, the processes and/or operations of the process flow 700 also can be applicable to the system 300.

At operation 704, the process flow 700 can comprise determining a request from a user equipment (UE) for network access.

At operation 706, the process flow 700 can comprise determining the CU-UP as one of a group of CU-UPs of the network topology that are initially determined as comprising a connection to a distributed unit having received the request.

At operation 708, the process flow 700 can comprise detecting topology connections of the network topology that comprise the known aspect.

At operation 710, the process flow 700 can comprise querying distributed units (DUs) that are part of the network topology for connections of the DUs to at least one of the CU-UPs.

At operation 712, the process flow 700 can comprise generating table data representative of a mapping table of topology connections of a network topology comprising an open radio access network topology or at least a fifth generation (5G) communication network topology.

At operation 714, the process flow 700 can comprise, in response to receipt of an indication of a failed connection between a distributed unit that is part of the network topology and another central unit user plane other than the central unit user plane, analyzing, by the system, the central unit user plane.

At operation 716, the process flow 700 can comprise comparing CU-UPs of the network topology, comprising the CU-UP, based on the topology connections.

At operation 718, the process flow 700 can comprise analyzing, using an artificial intelligence model, known topology connections of the network topology wherein the determining of the CU-UP comprises determining the CU-UP based on a result of the analyzing.

At operation 720, the process flow 700 can comprise selecting a central unit user plane (CU-UP) to which to assign the UE based on a known aspect of a network topology of a communication network comprising the CU-UP.

At operation 722, the process flow 700 can comprise facilitating making the request for the network access by the UE to the CU-UP.

At operation 724, the process flow 700 can comprise allocating user plane resources based on the selecting of the CU-UP.

At operation 726, the process flow 700 can comprise analyzing a response from the CU-UP for an unknown aspect associated with an unknown topology connection of the network connection.

At operation 728, the process flow 700 can comprise updating a knowledge data store employed for CU-UP determination with the unknown aspect.

At operation 730, the process flow 700 can comprise updating the mapping table, based on a failed response of a topology connection, of the topology connections, wherein the failed response is determined to have been caused by a removal of the topology connection.

At operation 732, the process flow 700 can comprise training the artificial intelligence model based on the additional topology connections and/or unknown aspect.

At operation 734, the process flow 700 can comprise generating an alert to a vendor of a DU or CU-UP in response to a non-functioning and previously known topology connection.

For simplicity of explanation, the computer-implemented methodologies and/or processes provided herein are depicted and/or described as a series of acts. The subject innovation is not limited by the acts illustrated and/or by the order of acts, for example acts can occur in one or more orders and/or concurrently, and with other acts not presented and described herein. The operations of process flows of diagrams 700 are example operations, and there can be one or more embodiments that implement more or fewer operations than are depicted.

Furthermore, not all illustrated acts can be utilized to implement the computer-implemented methodologies in accordance with the described subject matter. In addition, the computer-implemented methodologies could alternatively be represented as a series of interrelated states via a state diagram or events. Additionally, the computer-implemented methodologies described hereinafter and throughout this specification are capable of being stored on an article of manufacture to facilitate transporting and transferring the computer-implemented methodologies to computers. The term article of manufacture, as used herein, is intended to encompass a computer program accessible from any machine-readable device or storage media.

In summary, provided is a system for determining unknown, new and/or changed radio system architecture/topology, including available system connections between nodes, NFs, CU-UPs, DUs and/or CU-CPs. An example system can comprise a processor; and a memory that stores executable instructions that, when executed by the processor, facilitate performance of operations, comprising determining a request from a user equipment (UE) for network access, and selecting a central unit user plane (CU-UP) to which to assign the UE based on a known aspect of a network topology of a communication network comprising the CU-UP. The system can provide a learned and dynamic approach to network topology analysis, and can allow for determining a CU-UP based on network topology, connection availability, loading, downtime, traffic connections, bandwidth and/or one or more other KPIs.

An advantage of the one or more embodiments of the aforementioned system, method and/or non-transitory machine-readable medium can be learning, by the system, of which CU-UP to target, such as for node deployment or a user entity requesting access to the radio network.

Another advantage of the one or more embodiments of the aforementioned system, method and/or non-transitory machine-readable medium can be ability to address changed, new, and/or damaged topology connections via discovery over time and subsequent topology learning by the system.

Yet another advantage of the one or more embodiments of the aforementioned system, method and/or non-transitory machine-readable medium can be ability to navigate a topology having a disaggregated architecture where different vendors provide different connection KPIs.

In one or more embodiments of the aforementioned system, method and/or non-transitory machine-readable medium, analysis of known topology connections can be performed using an analytical model, such as an artificial intelligence model, where the determining of a CU-UP can comprise determining the CU-UP based on a result of the analyzing. An advantage of these one or more processes can be a learned and dynamic approach to network topology analysis, and can allow for determining a CU-UP not only based on network topology availability, but additionally and/or alternatively upon one or more other criteria, such as loading, downtime, traffic connections, bandwidth and/or one or more other learned context or KPIs of a radio network topology.

A practical application of the systems, computer-implemented methods and/or non-transitory computer-readable mediums described herein can be realtime analysis of topology context and connections, such as to allow for selection of a node of a radio network for one or more reasons, such as in view of a UE network access request. Overall, such computerized tools can constitute a concrete and tangible technical improvement in the field of radio system diagnostics, without being limited thereto.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein are inherently and/or inextricably tied to computer technology and cannot be implemented outside of a computing environment. For example, one or more processes performed by one or more embodiments described herein can more efficiently, and even more feasibly, provide dynamic and adaptable radio network topology analysis, as compared to existing systems and/or techniques. Systems, computer-implemented methods and/or computer program products facilitating performance of these processes are of great utility in the fields of radio network and radio system diagnostics and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively analyze radio network topology to generate a node selection in the time that one or more embodiments described herein can facilitate these processes. And, neither can the human mind nor a human with pen and paper electronically perform one or more of these processes as conducted by one or more embodiments described herein.

In one or more embodiments, one or more of the processes described herein can be performed by one or more specialized computers (e.g., a specialized processing unit, a specialized classical computer, and/or another type of specialized computer) to execute defined tasks related to the one or more technologies describe above. One or more embodiments described herein and/or components thereof can be employed to solve new problems that arise through advancements in technologies mentioned above, employment of cloud computing systems, computer architecture and/or another technology.

One or more embodiments described herein can be fully operational towards performing one or more other functions (e.g., fully powered on, fully executed and/or another function) while also performing the one or more operations described herein.

### Example Operating Environment

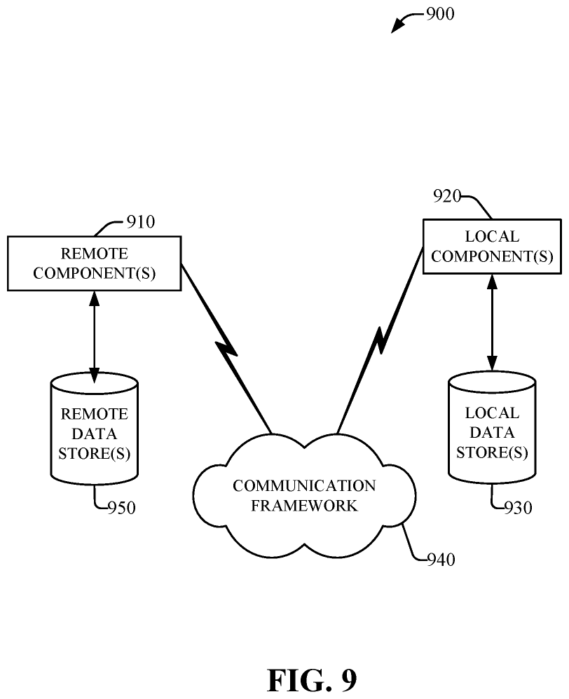

FIG. 9 is a schematic block diagram of an operating environment 900 with which the described subject matter can interact. The operating environment 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, radio access network devices, gateway devices, femtocell devices, servers, etc.

The operating environment 900 also comprises one or more local component(s) 920. The local component(s) 920 can be hardware and/or software (e.g., threads, processes, computing devices). In some embodiments, local component(s) 920 can comprise an automatic scaling component and/or programs that communicate/use the remote resources 910 and 920, etc., connected to a remotely located distributed computing system via communication framework 940.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The operating environment 900 comprises a communication framework 940 that can be employed to facilitate communications between the remote component(s) 910 and the local component(s) 920, and can comprise an air interface, e.g., interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

### Example Computing Environment

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Referring still to FIG. 10, the example computing environment 1000 which can implement one or more embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), and can include one or more external storage devices 1016 (e.g., a magnetic floppy disk drive (FDD) 1016, a memory stick or flash drive reader, a memory card reader, etc.). While the internal HDD 1014 is illustrated as located within the computer 1002, the internal HDD 1014 can also be configured for external use in a suitable chassis (not shown). Additionally, while not shown in the computing environment 1000, a solid state drive (SSD) could be used in addition to, or in place of, an HDD 1014.

Other internal or external storage can include at least one other storage device 1020 with storage media 1022 (e.g., a solid state storage device, a nonvolatile memory device, and/or an optical disk drive that can read or write from removable media such as a CD-ROM disc, a DVD, a BD, etc.). The external storage 1016 can be facilitated by a network virtual machine. The HDD 1014, external storage device(s) 1016 and storage device (e.g., drive) 1020 can be connected to the system bus 1008 by an HDD interface 1024, an external storage interface 1026 and a drive interface 1028, respectively.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. The network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

The above description of illustrated embodiments of the one or more embodiments described herein, comprising what is described in the Abstract, is not intended to be exhaustive or to limit the described embodiments to the precise forms described. While one or more specific embodiments and examples are described herein for illustrative purposes, various modifications are possible that are considered within the scope of such embodiments and examples, as those skilled in the relevant art can recognize.

In this regard, while the described subject matter has been described in connection with various embodiments and corresponding figures, where applicable, other similar embodiments can be used or modifications and additions can be made to the described embodiments for performing the same, similar, alternative, or substitute function of the described subject matter without deviating therefrom. Therefore, the described subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures to optimize space usage or enhance performance of user equipment. A processor can also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. However, there is no intention to limit the various embodiments to the one or more specific forms described, but on the contrary, the intention is to cover all modifications, alternative constructions, and equivalents falling within the spirit and scope.

In addition to the various implementations described herein, other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a processor; and
a memory that stores executable instructions that, when executed by the processor, facilitate performance of operations, comprising:
determining a request from a user equipment (UE) for network access; and
selecting a central unit user plane (CU-UP) to which to assign the UE based on a known aspect of a network topology of a communication network comprising the CU-UP.

2. The system of claim 1, wherein the operations further comprise:
detecting topology connections of the network topology that comprise the known aspect.

3. The system of claim 2, wherein the operations further comprise:
comparing CU-UPs of the network topology, comprising the CU-UP, based on the topology connections.

4. The system of claim 1, wherein the determining of the CU-UP comprises:
determining the CU-UP as one of a group of CU-UPs of the network topology that are initially determined as comprising a connection to a distributed unit having received the request.

5. The system of claim 1, wherein the operations further comprise:
analyzing, using an artificial intelligence model, known topology connections of the network topology wherein the determining of the CU-UP comprises determining the CU-UP based on a result of the analyzing.

6. The system of claim 1, wherein the operations further comprise:
analyzing a response from the CU-UP for an unknown aspect associated with an unknown topology connection of the network connection; and
updating a knowledge data store employed for CU-UP determination with the unknown aspect.

7. The system of claim 1, wherein the operations further comprise:
facilitating making the request for the network access by the UE to the CU-UP.

8. The system of claim 1, wherein the network topology is enabled using an open radio access network protocol or at least a fifth generation (5G) communication network protocol.

9. A non-transitory machine-readable medium, comprising executable instructions that, when executed by a processor facilitate performance of operations, comprising:
detecting topology connections of a network topology;
comparing central unit user planes (CU-UPs) of the network topology, based on the topology connections; and
determining a CU-UP of the CU-UPs to which to assign the UE based on a result of the comparing.

10. The non-transitory machine-readable medium of claim 9, wherein the topology connections comprise connections between the CU-UPs and distributed units (DUs) that are part of the network topology.

11. The non-transitory machine-readable medium of claim 9, wherein the comparing comprises:
using an artificial intelligence model to compare the topology connections to known topology connections stored at a knowledge data store, resulting in detection of additional topology connections that are not comprised by the knowledge data store.

12. The non-transitory machine-readable medium of claim 11, wherein the operations executed by the processor further comprise:
training the artificial intelligence model based on the additional topology connections.

13. The non-transitory machine-readable medium of claim 9, wherein the operations executed by the processor further comprise:
comparing the CU-UPs based on current loading conditions of the CU-UPs.

14. The non-transitory machine-readable medium of claim 9, wherein the operations executed by the processor further comprise:
querying distributed units (DUs) that are part of the network topology for connections of the DUs to at least one of the CU-UPs.

15. A method, comprising:
generating, by a system comprising a processor, table data representative of a mapping table of topology connections of a network topology comprising an open radio access network topology or at least a fifth generation (5G) communication network topology; and
based on the mapping table, selecting, by the system, a central unit user plane of the network topology to which to assign a user device associated with a user entity that is requesting access to the network topology.

16. The method of claim 15, further comprising:
determining a topology connection of the topology connections of the network topology based on a query to a central unit user plane or a distributed unit of the network topology; and comparing, by the system, the topology connection to known topology connections of the mapping table.

17. The method of claim 16, further comprising:
analyzing, by the system, the mapping table using an artificial intelligence model trained on the known topology connections of the network topology; and
determining, by the system, the central unit user plane based on the known topology connections.

18. The method of claim 15, further comprising:
in response to receipt of an indication of a failed connection between a distributed unit that is part of the network topology and another central unit user plane other than the central unit user plane, analyzing, by the system, the central unit user plane.

19. The method of claim 15, further comprising:
updating, by the system, the mapping table, based on a failed response of a topology connection, of the topology connections, wherein the failed response is determined, by the system, to have been caused by a removal of the topology connection.

20. The method of claim 15, further comprising:
allocating, by the system, user plane resources based on the selecting of the central unit user plane.
